(19) United States
(12) Patent Application Publication
(10) Pub. No.: US 2026/0129727 A1
(43) Pub. Date: May 7, 2026

(54) MULTI-COLOR LED MIXED COLOR BALANCE CALIBRATION CIRCUIT

(71) Applicant: Schneider Electric Industries SAS, Rueil-Malmaison (FR)

(72) Inventor: Weihi FEI, Shanghai (CN)

(73) Assignee: Schneider Electric Industries SAS, Rueil-Malmaison (FR)

(21) Appl. No.: 19/383,456

(22) Filed: Nov. 7, 2025

(30) Foreign Application Priority Data
Nov. 7, 2024 (CN) 2024115854215

(51) Int. Cl. H05B 45/24; H05B 45/50

(52) U.S. Cl. CPC H05B 45/24; H05B 45/50

(57) ABSTRACT

The disclosure relates to a circuit for multi-color LED mixed color balance calibration, the circuit including: an LED loop including one or more LED channels with different colors, each of the one or more LED channels with different colors includes one or more LEDs with a same color and an LED switch; an LED junction configured to be connected to the one or more LED channels with different colors; a voltage divider resistor configured to be connected between the LED junction and a color calibration switch; the color calibration switch configured to enable or disable color calibration based on a received color calibration enable signal; and a microprocessor configured to: generate a color calibration enable signal, measure a first voltage, based on the generated color calibration enable signal, and adjust a mixed color output by the LED loop based on the measured first voltage.

### CROSS-REFERENCE TO RELATED APPLICATION

This application is based on and claims priority to Chinese Patent Application No. 202411585421.5, filed on Nov. 7, 2024 in the Chinese Patent Office, the contents of which being herein incorporated by reference in its entirety.

### TECHNICAL FIELD

The disclosure relates to multi-color LED color mixing technology, in particular to a circuit for multi-color LED mixed color balance calibration.

### BACKGROUND

Light-emitting diode (LED) is a light source with high energy efficiency, high brightness and small volume, which is widely used in electrical equipment, displays and lighting systems. In the application scenario where LED is used as the backlight of the display, multi-color LED such as RGB can be used as the light source, and the backlight can show various color effects through mixed color driving to achieve color indication with specific meaning. In the design of multi-color backlight LED of display, in order to keep the mixed colors consistent between each display backlight, it is necessary to consider the color balance compensation in the backlight driving design.

In addition, how to use LED safely is an important topic of LED driving technology. Short-circuit fault sometimes occurs in the production and use of LED leads, therefore, it is necessary to effectively protect the fault of short-circuit of the LED in the design of LED drive to avoid the burning of LED drive power supply and even the collapse of the whole equipment power supply system.

### SUMMARY

The disclosure provides a circuit for multi-color light-emitting diode (LED) mixed color balance calibration, the circuit comprising: an LED loop comprising one or more LED channels with different colors, each of the one or more LED channels with different colors comprises one or more LEDs with a same color and an LED switch; an LED junction configured to be connected to the one or more LED channels with different colors; a voltage divider resistor configured to be connected between the LED junction and a color calibration switch; the color calibration switch configured to enable or disable color calibration based on a received color calibration enable signal; and a microprocessor configured to: generate a color calibration enable signal, measure, based on the generated color calibration enable signal, a first voltage at the LED junction when each of the one or more LED channels with different colors is individually turned on, and adjust a mixed color output by the LED loop based on the measured first voltage.

According to an embodiment of the disclosure, the microprocessor is configured to send a turn-on signal for the LED switch corresponding to the one or more LED channels with different colors to the LED loop based on the color calibration enable signal.

According to an embodiment of the disclosure, the microprocessor is configured to adjust, based on the measured first voltage when each of the one or more LED channels with different colors is individually turned on, a turn-on pulse width of the turn-on signal for the LED switch corresponding to the one or more LED channels with different colors.

According to an embodiment of the disclosure, when the received color calibration enable signal is at a high level, the color calibration switch enables color calibration.

According to the embodiment of the disclosure, the microprocessor is further configured to determine, according to the color calibration enable signal, whether an LED short-circuit occurs in each of the one or more LED channels with different colors, based on the first voltage at the LED junction when each of the one or more LED channels with different colors is individually turned on, to turn off the LED switch corresponding to the LED channel determined to have an LED short circuit.

According to the embodiment of the disclosure, the LED loop comprises N LED channels with different colors, wherein N is an integer greater than or equal to 2.

According to an embodiment of the disclosure, each of the one or more LED channels with different colors further comprises one or more LED series resistors connected to a corresponding one of one or more LED with different colors.

According to an embodiment of the disclosure, the LED switch corresponding to the one or more LED channels with different colors is a metal oxide semiconductor field effect transistor (MOSFET), and a gate of a corresponding LED switch receives a turn-on signal for the LED switch corresponding to the one or more LED channels with different colors from the microprocessor.

According to an embodiment of the disclosure, the circuit further comprises an LED short-circuit protection switch configured to be connected to the LED junction, and an LED short-circuit detection module configured to be connected to the LED junction and the LED short-circuit protection switch, measure a second voltage at the LED junction based on the received color calibration enable signal, and determine whether an LED short-circuit occurs to turn off or turn on the LED short-circuit protection switch based on the measured second voltage.

According to the embodiment of the disclosure, the LED short-circuit protection switch is configured to be turned on when the received color calibration enable signal is at a low level, and the LED short-circuit detection module measures the second voltage at the LED junction.

The disclosure provides an electronic device, which comprises a regulated power supply module and a circuit described in any one of the foregoing, wherein the circuit is configured to be connected to the regulated power supply module.

In this disclosure, the proposed circuit for calibrating the mixed color balance of multi-color LEDs can simultaneously introduce a color balance compensation mechanism to the mixed driving of multi-color LEDs, so that the colors of the backlight of each display are consistent, and the problem of color consistency among products existing in a multi-channel multi-color LED color mixing system is solved.

### BRIEF DESCRIPTION OF DRAWINGS

The above and other aspects, features and advantages of specific embodiments of the disclosure will become more apparent from the following description taken in conjunction with the accompanying drawings, in which:

FIG. 1 is a schematic principle block diagram showing a first implementation of the multi-color LED mixed color balance calibration circuit provided by the embodiment of the disclosure;

FIG. 2 is a schematic principle block diagram showing a second implementation of the multi-color LED mixed color balance calibration circuit provided by the embodiment of the disclosure;

FIG. 3 is a circuit diagram showing an example of a multi-color LED mixed color balance calibration circuit with short-circuit protection provided by the embodiment of the disclosure;

FIG. 4 is a flowchart of LED color calibration and short-circuit protection achieved by the multi-color LED mixed color balance calibration circuit provided by the embodiment of the disclosure.

### DETAILED DESCRIPTION

Before the following detailed description, it may be beneficial to explain the definitions of some words and phrases used throughout the disclosure. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. For example, the controller may include, for example, an application specific integrated circuit (ASIC), a general or special central processing unit (CPU), a digital signal processor (DSP), and a programmable logic device such as a field programmable gate array (FPGA). The controller can be manufactured as a single printed circuit board (PCB) or distributed on several interconnected PCBs. The controller may include other processing circuits. For example, the controller may include two processing circuits such as an FPGA and a CPU connected to each other on a PCB. The functions associated with any particular controller can be centralized or distributed, whether local or remote. The phrase “at least one”, when used with a list of items, means that different combinations of one or more of the listed items can be used, and only one item in the list may be needed. For example, “at least one of a, b and c” includes any one of the following combinations: A, B, C, A and B, A and C, B and C, A and B and C. At the same time, in the description of the disclosure, the terms “first” and “second” are only used to distinguish descriptions, and cannot be understood as indicating or implying relative importance or ordering. In the embodiment of the present disclosure, unless otherwise specified, “connected” does not necessarily mean “directly connected” or “directly contacted”, but only needs to be electrically connected.

Definitions of other specific words and phrases are provided throughout this disclosure. It should be understood by those skilled in the art that in many cases, if not most cases, such definitions also apply to the previous and future uses of words and phrases so defined.

The following description of various embodiments of the principles of the present disclosure in this patent application document taken in conjunction with the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order or sequential order shown to achieve the desired results. In certain embodiments, multitasking and parallel processing may be advantageous.

The text and drawings are provided as examples only to help understand the present disclosure. They should not be construed as limiting the scope of the claims appended to this disclosure in any way. Throughout the drawings, like reference numerals generally indicate like elements. Although certain embodiments and examples have been provided, based on the disclosure, it is clear to those skilled in the art that changes can be made to the illustrated embodiments and examples without departing from the scope of the disclosure.

In the application scenario of multi-color backlight LED of display, the backlight color of display can be achieved by mixing the light of multi-color LED according to the preset ratio of turn-on time, so as to present the color required by user interface. For example, the backlight achieved by multi-channel multi-color LED can display white under normal conditions, and can also display special alert color (blue), warning color (yellow), alarming color (red) and so on.

However, in the existing solutions, the LED turn-on time ratio of these specific color backlights is preset and fixed. However, in the large-scale mass production of products, the turn-on voltage of LEDs is different between different batches, which results in the difference of the current of each color LED in parallel multi-channels. If continuing to use the fixed multi-color backlight turn-on time ratio, it will cause the actual mixed backlight colors to be different among products. This color deviation will not only reduce the customer's experience, but in some cases, it may even result in customer's misjudgment due to inconsistent colors.

Therefore, in the design of multi-color backlight LED of display, it is necessary to consider introducing color balance compensation mechanism to keep the backlight color of each display consistent.

FIG. 1 is a schematic principle block diagram showing a first implementation 100 of a multi-color LED mixed color balance calibration circuit provided by the embodiment of the disclosure.

Referring to FIG. 1, the multi-color LED mixed color balance calibration circuit 100 may include an LED loop 101, an LED junction 102, a voltage divider resistor 103, a color calibration switch 104 and a microprocessor 105.

The LED loop 101 may include one or more LED channels with different colors, and each of the one or more LED channels with different colors may include one or more LEDs with a same color and an LED switch. Among them, the LED switch may receive the turn-on signal from the microprocessor 105 and control the turn-on and turn-off of the corresponding LED channel based on the received turn-on signal. In one example, the turn-on signal may be a pulse width modulation (PWM) signal generated by the microprocessor 105, and the turn-on of the corresponding LED channel may be achieved in a high-level state of the PWM signal. By adjusting the turn-on time ratio of LED, that is, adjusting the turn-on pulse width of the PWM signal, the mixed color output by LED loop may be controlled.

In some embodiments, the LED loop 101 may include N parallel LED channels with different colors, where N is an integer greater than or equal to 2. Each of the N LED channels may include one or more LEDs with the same color and the LED switch. For example, in the hybrid driving of red, green and blue (RGB) LED, the LED loop may include three LED channels, which are red channel, green channel and blue channel, respectively. Among them, the red LED channel may include a red LED and a red LED switch, the green LED channel may include a green LED and a green LED switch, and the blue LED channel may include a blue LED and a blue LED switch.

In some embodiments, the one or more LED channels with different colors may further include one or more LED series resistors, which may be connected to a corresponding one of the one or more LEDs with different colors. For example, in the hybrid driving of red, green and blue (RGB) LEDs, the red LED channel, the green LED channel and the blue LED channel may include respective series resistors.

In some embodiments, the LED switch corresponding to the one or more LED channels with different colors is a metal oxide semiconductor type field effect transistor (MOS transistor), and the gate of the LED switch corresponding to the one or more LED channels with different colors receives a turn-on signal for the LED switch from the microprocessor 105.

The LED junction 102 may be configured to be connected to the one or more LED channels with different colors. The LED junction 102 may also be configured to be connected to an ADC conversion module of the microprocessor 105, so that the microprocessor 105 may obtain the voltage at the LED junction 102.

The voltage divider resistor 103 may be configured to be connected between the LED junction 102 and the color calibration switch 104. Due to the existence of the voltage divider resistor 103, the current of the LED loop 101 may be detected by detecting the voltage at the LED junction 102.

The color calibration switch 104 may be configured to receive a color calibration enable signal from the microprocessor 105 and enable or disable color calibration based on the received color calibration enable signal. In some embodiments, the color calibration switch may enable color calibration based on the received color calibration enable signal being high level, and may disable color calibration based on the received color calibration enable signal being low level. In some other implementations, the color calibration switch may enable color calibration based on the received color calibration enable signal being low level, and may disable color calibration based on the received color calibration enable signal being high level. However, embodiments of the disclosure are not limited thereto.

The microprocessor 105 may be configured to generate the color calibration enable signal, measure a first voltage at the LED junction 102 when each of the one or more LED channels with different colors is individually turned on based on the generated color calibration enable signal, and adjust a mixed color output by the LED loop 101 based on the measured first voltage.

When the color calibration is enabled based on the color calibration enable signal, the microprocessor 105 may send the turn-on signal for the LED switch corresponding to the one or more LED channels with different colors to the LED loop 101, thus enable the detection of the turn-on voltage of each LED. Wherein, the turn-on signal may be a signal that enables each LED channel to be turned on one by one in time, so that each LED channel may be turned on respectively. In other words, in a plurality of LED channels controlled by the turn-on signal, at any time point, only the LED in one LED channel may be turned on. In this case, the microprocessor 105 may measure the voltage at the LED junction 102 when each LED channel is turned on, as the actual turn-on voltage of each LED. Based on the obtained actual turn-on voltage of each LED, the turn-on pulse width of the turn-on signal for the LED switch corresponding to the one or more LED channels with different colors may be adjusted to adjust the output color of the LED loop 101.

In some embodiments, in the case that the color calibration enable signal enables color calibration, the microprocessor 105 may determine whether the LED short-circuit occurs in the LED channel based on the measured first voltage at the LED junction 102 when each channel in the one or more LED channels with different colors is individually turned on. The microprocessor 105 may determine whether the LED short-circuit occurs by comparing the measured voltage of the LED junction 102 with a threshold voltage (e.g., regulated power supply voltage). For example, when the LED short-circuit occurs, the measured voltage at the LED junction 102 is close to the regulated power supply voltage, while when short-circuit of the LED does not occur, the measured voltage at the LED junction 102 is obviously less than the regulated power supply voltage, for example, the measured voltage at the LED junction 102 is equal to the regulated power supply voltage minus the turn-on voltage of LED. Therefore, the microprocessor 105 may determine whether there is short-circuit of the LED in the circuit by the program, and send a signal to turn off the LED switch corresponding to the LED channel determined as short-circuit, so as to achieve the purpose of effectively protecting the fault of short-circuit of the LED and protecting the regulated power supply.

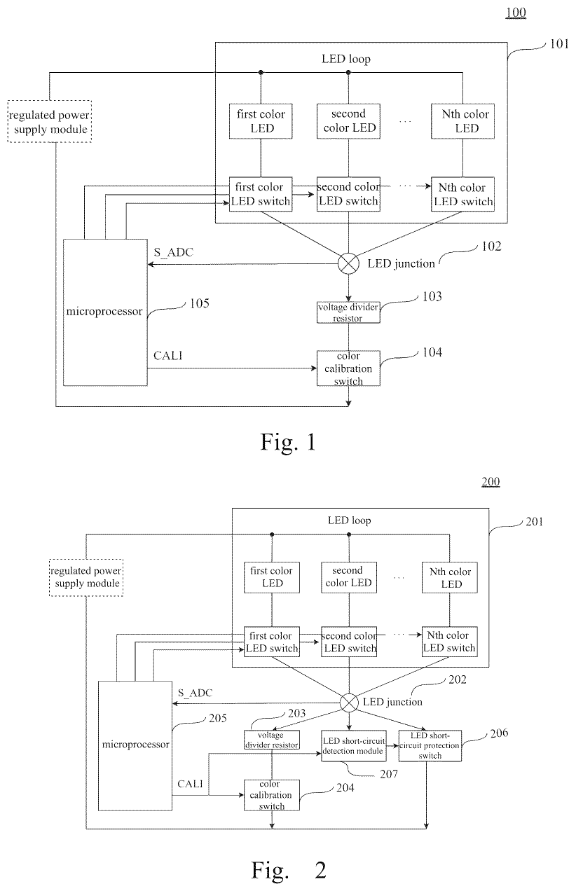

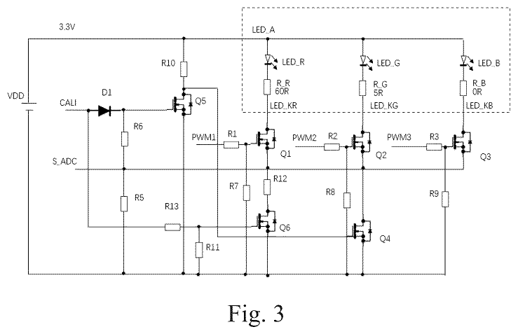

FIG. 2 is a schematic principle block diagram showing a second implementation 200 of the multi-color LED mixed color balance calibration circuit provided by the embodiment of the disclosure.

The multi-color LED mixed color balance calibration circuit 200 according to the second implementation may have a short-circuit protection function.

Referring to FIG. 2, the multi-color LED mixed color balance calibration circuit with short-circuit protection includes an LED loop 201, an LED junction 202, a voltage divider resistor 203, a color calibration switch 204, an LED short-circuit protection switch 206, an LED short-circuit detection module 207 and a microprocessor 205. Among them, the LED loop 201, the LED junction 202, the voltage divider resistor 203, the color calibration switch 204 and the microprocessor 205 are similar to the LED loop 101, the LED junction 102, the voltage divider resistor 103, the color calibration switch 104 and the microprocessor 105 in FIG. 1.

The LED short-circuit protection switch 206 may be configured to be connected to the LED junction 202. The LED short-circuit detection module 207 may be configured to be connected to the LED junction 202 and the LED short-circuit protection switch 206.

The LED short-circuit detection module 207 may be configured to receive a color calibration enable signal from the microprocessor 205, measure a second voltage at the LED junction 202 based on the received color calibration enable signal, and determine whether the LED short-circuit occurs based on the measured second voltage to turn off or turn on the LED short-circuit protection switch 206.

In some embodiments, the LED short-circuit protection switch 206 may be configured to be turned on when the received color calibration enable signal is at a low level, and the LED short-circuit detection module 207 measures the second voltage at the LED junction 202.

In some embodiments, when the LED short-circuit occurs, the voltage at the LED junction 202 rises when the switch of the corresponding LED channel is turned on, so that the LED short-circuit detection module 207 outputs a first level signal to turn off the LED short-circuit protection switch 206 and protect the regulated power supply to avoid short-circuit of the load. When the LED short-circuit does not occur, the voltage at the LED junction 202 is at a low level, so that the LED short-circuit detection module 207 outputs a second level signal to turn on the LED short-circuit protection switch 206, and the system works normally.

In some embodiments, the microprocessor 205 may detect the voltage at the LED junction 202, determine whether the LED short-circuit occurs by detecting the level of the voltage, and report the signal to the user.

In the first implementation 100 of the multi-color LED mixed color balance calibration circuit described above, the LED short-circuit protection may be achieved by connecting a voltage sampling circuit in series in the LED power supply line and detecting the voltage of the sampling circuit by the microprocessor 205. When the LED short-circuit occurs, the microprocessor 205 detects the abnormal rise in the voltage in the sampling circuit, thus sending out a control signal to turn off the LED driving load. However, the above-mentioned program monitoring type method of the LED short-circuit protection has some shortcomings, such as the sampling circuit consumes line voltage, and the response is not timely due to the need to interact with the microprocessor 205 for data and signals.

In addition, under normal circumstances, in the application scenario of the LED short-circuit protection, there is another commonly used method—the LED drive module constant current source method. In this method, the LED load is connected in series in the output loop of the constant current drive module, and even if the LED load occurs short-circuit, the current of the power supply system will not increase because the drive module is constant current output. For example, the LED constant current drive including emitter follower circuit is introduced, and the emitter bias resistance plays a role in adjusting the LED drive current and determining the current of the LED power supply loop, so even if the LED short-circuit occurs, the current of the LED power supply loop remains unchanged and does not affect the output current of the power supply. However, due to the introduction of the constant current drive module, the method of the LED short-circuit protection has the disadvantages of increasing the system cost and the system complexity.

In the second implementation 200 of the multi-color LED mixed color balance calibration circuit, the LED short-circuit protection switch 206 and the LED short-circuit detection module 207 are adopted to achieve the short-circuit protection function without consuming the voltage in the LED driving circuit. At the same time, this implementation method also has the advantages of low implementation cost and fast response speed of short-circuit protection.

FIG. 3 is a circuit diagram showing an example of a multi-color LED mixed color balance calibration circuit with short-circuit protection provided by an embodiment of the disclosure.

Referring to FIG. 3, in some embodiments, a multi-color LED mixed color balance calibration circuit with short-circuit protection may include an LED loop, an LED junction, a voltage divider resistor R12, and MOS transistors Q4, Q5 and Q6.

The LED loop may include LED channels with different colors, wherein the LED channels with different colors may include multi-channel LED load (as shown in the dotted line in FIG. 3), and wherein, LED_A may be the positive electrode common terminal of the multi-channel LED load and connected to the positive electrode of the regulated power supply. In some embodiments, the multi-channel LED may be red, green and blue (RGB) three-channel LEDs, which are red LED LED_R, green LED LED_G and blue LED LED_B, respectively. In addition, the LED channels with different colors may also include series resistors R_R, R_G and R_B of LEDs, which are connected to one of the multi-channel LEDs, respectively. In some embodiments, the resistance value of the LED series resistors may be determined according to the following Equation 1:

$$R = ( VDD - VFD ) / IFD \qquad [ Equation 1 ]$$

Where VDD is the voltage of the regulated power supply, IFD is the rated current, and VFD is the turn-on voltage at the rated current when each of the LED channels with different colors is turned on individually, which are VFD_R, VFD_G, VFD_B, respectively.

The LED channels with different colors in the LED loop may also include LED switches corresponding to each of the multi-channel LEDs, which are metal oxide semiconductor field effect transistors (MOS transistors) Q1, Q2 and Q3, respectively. Among them, LED switches Q1, Q2 and Q3 may be connected to multi-channel LEDs LED_R, LED_G and LED_B, respectively. The drains of the LED switches are connected with the multi-channel LEDs, respectively. The sources of the LED switches are connected together to form the LED junction. The gate of the LED switch receives the turn-on signal corresponding to the LED switch from the microprocessor.

In some embodiments, the turn-on signals corresponding to the LED switches may be PWM signals, which are PWM1, PWM2 and PWM3, respectively. In the state that the PWM1, PWM2 and PWM3 are at high level, the LED switches Q1, Q2 and Q3 corresponding to the PWM1, PWM2 and PWM3 are respectively turned on. The high-level pulses of PWM signals in each channel do not overlap each other on the time axis, that is, only the LED of one channel is turned on at any time. Therefore, the ratio of turn-on pulse width of PWM signals in each channel, such as the turn-on pulse width ratio P1:P2:P3 of the PWM1, PWM2 and PWM3, determines the multi-color LED mixed color output by the LED loop.

Since in actual production, the turn-on voltage of LED is different between different batches. When the voltage of the regulated power supply and the resistance values of R_R, R_G and R_B are fixed, the actual turn-on current of the LED in each channel is different. For example, the actual turn-on current of a red LED as shown in FIG. 3 may be determined according to the following Equation 2:

$$I \times 1 = ( VDD - VFD\_ Rx ) / R\_R \qquad [ Equation 2 ]$$

Where Ix1 is the actual conduction current of the red LED, VFD_Rx is the actual turn-on voltage of the red LED, VDD is the voltage of the regulated power supply, and R_R is the resistance value of the resistor connected in series with the LED in the red LED channel.

Since the actual turn-on voltage of red LED is randomly distributed around the typical value VFD_R, the actual turn-on current Ix1 flowing through the LED changes around the rated current IFD, which leads to the difference of the actual currents flowing through the LEDs in each channel. Therefore, there will be the phenomenon that the colors obtained by multi-color LED mixing are inconsistent, and color balance calibration is needed to compensate for the different load currents of each channel. The realization of color balance calibration will be further described later with reference to FIG. 3.

The LED junction may be formed by connecting the sources of LED switches of each channel together, and the LED junction is connected to the ADC conversion module of the microprocessor, so that the microprocessor may measure the voltage S_ADC at the LED junction. Here, the measured voltage S_ADC may be the first voltage when each of the LED channels with different colors is turned on individually. The LED junction may be connected to the negative electrode of the power supply through the MOS transistor Q4 and the MOS transistor Q6, respectively, thus forming a first connection mode and a second connection mode of the LED driving circuit, respectively. Among them, the MOS transistor Q4 is a short-circuit protection switch, and the MOS transistor Q6 is a color calibration switch. The LED junction may also be connected to the gate of the MOS transistor Q5 via a resistor R6 and to the negative electrode of the power supply via a resistor R5.

The microprocessor may generate a color calibration enable signal (CALI signal) and output the CALI signal via a general-purpose input-output port (GPIO port). The CALI signal is output to the gate of the MOS transistor Q5 via a diode D1. The drain of the MOS transistor Q5 is connected to the gate of the MOS transistor Q4, and it is connected to the positive electrode of the power supply via the resistor R10. The drain of the MOS transistor Q4 is connected to the LED junction. The drain of the MOS transistor Q6 is connected to the LED junction via the voltage divider resistor R12, and the gate of the MOS transistor Q6 receives the CALI signal from the microprocessor, and turns itself on or off according to whether the received CALI signal is at high level or low level, thus enabling or disabling the color calibration.

When the CALI signal received by MOS transistor Q6 is at a high level, the MOS transistors Q5 and Q6 are turned on. Since the MOS transistor Q5 is turned on, the gate of the MOS transistor Q4 connected to the drain of the MOS transistor Q5 is at a low level, thus the MOS transistor Q4 is turned off. Under the above circumstances, the LED driving circuit constructed according to the first connection mode is implemented.

Due to the existence of the voltage divider resistor R12, the microprocessor may measure the voltage S_ADC at the LED junction, thus obtaining the current of the LED loop. Here, the measured voltage S_ADC may be the first voltage when each of the LED channels with different colors is turned on individually. The current of the LED loop may be determined according to the following Equation 3:

$$I = ( {V}_{S \_ ADC} ) / R 12 \qquad [ Equation 3 ]$$

Where I may represent the current of the LED loop, V_{S_ADC} may represent the measured voltage at the LED junction, and R12 may represent the resistance value of the voltage divider resistor. When each of the LED channels with different colors is turned on individually in turn, the microprocessor may measure the voltage corresponding to the LED channels with different colors and further calculate the current of each LED channel. According to the obtained current of each LED channel, the turn-on pulse width of the turn-on signal for the LED in each channel may be compensated.

In some embodiments, it is assumed that in an ideal state, the current when the LED in each channel is turned on is equal, that is, I1=I2=I3=I, and the ideal turn-on pulse width ratio of the turn-on signal for the LED in each channel is P1:P2:P3. In the actual situation, the measured turn-on current of the LED in each channel is I1′=V1/R12, I2′=V2/R12, I3′=V3/R12, respectively, where V1, V2 and V3 are VS_ADC voltages measured when the LED in each channel is individually turned on. In this case, the turn on pulse width ratio of the turn-on signal for the LED in each channel may be adjusted according to the following Equation 4:

$$P {1}^{′} : P {2}^{′} : P {3}^{′} = ( P 1 / I {1}^{′} ) \text{:} ( P 2 / I {2}^{′} ) \text{:} ( P 3 / I {3}^{′} ) = ( P 1 / V 1 ) \text{:} ( P 2 / V 2 ) \text{:} ( P 3 / V 3 ) \qquad [ Equation 4 ]$$

In some embodiments, the microprocessor may also determine whether the LED short-circuit occurs according to the measured voltage S_ADC at the LED junction. In the case that the LED loop is turned on normally, the voltage S_ADC at the LED junction is at a low voltage (for example, less than 1V). Here, the measured voltage S_ADC may be the first voltage when each of the LED channels with different colors is turned on individually. However, when the LED short-circuit occurs, the voltage S_ADC at the LED junction will obviously rise, and generally, it is close to the regulated power supply voltage VDD. Therefore, the microprocessor may determine whether the LED short-circuit occurs by comparing the voltage S_ADC at the LED junction with the regulated power supply voltage VDD. For example, the microprocessor may compare the difference between the voltage value at the LED junction and VDD with a smaller voltage threshold (for example, Vt). When the difference between the voltage value at the LED junction and VDD is within the range of this voltage threshold, it is determined that the voltage at the LED junction is close to the power supply voltage VDD, and the LED short-circuit occurs.

When the microprocessor determines that the LED short-circuit occurs in the loop, the LEDs in each channel may be turned off by setting the turn-on signals PWM1, PWM2 and PWM3 to a low level, thus achieving the purpose of protecting the regulated power supply.

When the CALI signal received by the MOS transistor Q6 is at a low level, the MOS transistor Q6 is turned off. In this case, the LED driving circuit constructed according to the second connection mode is implemented.

When the LED short-circuit does not occur, the voltage S_ADC at the LED junction is at a low level due to the grounding resistor R5, so the MOS transistor Q5 is turned off. Here, the voltage S_ADC at the LED junction may be the second voltage. Since the drain of the MOS transistor Q5 is connected to the positive electrode of the power supply via the resistor R10, and it is connected to the gate of the MOS transistor Q4, the MOS transistor Q4 is turned on. As the MOS transistor Q4 is turned on, the voltage S_ADC at the LED junction is maintained at a low level, so the working state of the second connection mode keeps stable.

When the LED short-circuit occurs, the voltage S_ADC at the LED junction will obviously increase due to the MOS transistor Q4 is turned on. Here, the voltage S_ADC at the LED junction may be the second voltage. In this case, since the gate of the MOS transistor Q5 is connected to the LED junction via the resistor R6, the MOS transistor Q5 is turned on under the control of the voltage received by the gate. Since the MOS transistor Q5 is turned on, the gate of the MOS transistor Q4 connected to the drain of the MOS transistor Q5 is at a low level, so the MOS transistor Q4 is turned off. Through the above process, the LED short-circuit protection switch is turned off when the LED short-circuit occurs, so as to avoid the collapse of the LED driving module and even the whole power supply system when the LED short-circuit occurs, so that other modules of the equipment can operate as usual when the LED short-circuit occurs.

In some embodiments, protective resistors R1, R2 and R3 may be connected in series between the gates of the MOS transistors Q1, Q2 and Q3 and the microprocessor respectively, and pull-down resistors R7, R8 and R9 may be connected in series between the gates of the MOS transistors Q1, Q2 and Q3 and the negative electrode of power supply respectively. Among them, the protection resistors R1, R2 and R3 may prevent the processor output from overcurrent when the gate of the MOS transistor occurs short-circuit, thus playing a protective role. The pull-down resistors R7, R8, R9 may provide a certain potential at the start-up stage.

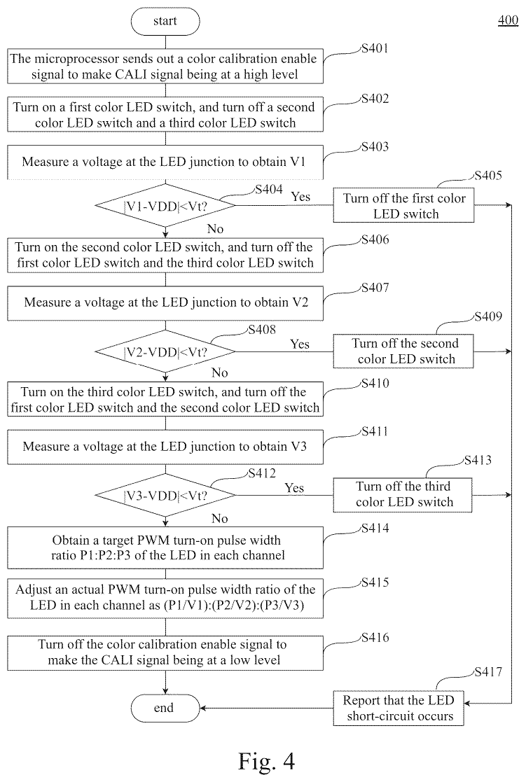

FIG. 4 is a flowchart showing an example method 400 for achieving LED color calibration and short-circuit protection by the multi-color LED mixed color balance calibration circuit provided by the embodiment of the disclosure.

Referring to FIG. 4, at step S401, the microprocessor sends out a color calibration enable signal to make the CALI signal being at a high level. The color calibration switch receives a color calibration enable signal from the microprocessor and enables or disables color calibration based on the received color calibration enable signal. For example, the color calibration switch enables color calibration based on the received color calibration enable signal being at a high level. In other implementations, the color calibration switch may enable color calibration based on the received color calibration enable signal being low. However, embodiments of the disclosure are not limited thereto.

At step S402, the microprocessor may send out a turn-on signal, which turns on the first color LED switch, and turns off the second color LED switch and the third color LED switch.

At step S403, the microprocessor may measure the voltage at the LED junction to obtain the actual turn-on voltage V1 when the LED channel of the first color is turned on individually.

At step S404, the microprocessor may compare the actual turn-on voltage V1 when the LED channel of the first color is turned on individually with the regulated power supply voltage VDD. For example, the microprocessor may compare the difference between the actual turn-on voltage V1 and the regulated power supply voltage VDD with a smaller voltage threshold Vt.

When the difference between the actual turn-on voltage V1 and the regulated power supply voltage VDD is within the range of the voltage threshold, it is determined that the LED short-circuit has occurred. The step proceeds to S405, and the microprocessor may turn off the first color LED switch, and the step further proceeds to S417 to report the occurrence of the LED short-circuit to the user.

At steps S406-S409 and S410-S413, operations similar to steps S402-S405 are performed, and the actual turn-on voltages V2 and V3 of the LED channel of the second color and the LED channel of the third color are obtained respectively, and the actual turn-on voltages V2 and V3 are compared with the regulated power supply voltage VDD, respectively, to determine whether the LED short-circuit occurs. When the difference between the actual on voltage V2 or V3 and the regulated power supply voltage VDD is within the range of the voltage threshold, it is determined that the LED short-circuit has occurred, and the step proceeds to S409 or S413, and the microprocessor may correspondingly turn off the second color LED switch or the third color LED switch, and the step further proceeds to S417 to report the occurrence of the LED short-circuit to the user.

At step S414, the microprocessor may obtain the target PWM turn-on pulse width ratio P1:P2:P3 of the LED in each channel.

At step S415, the microprocessor may adjust the actual PWM turn-on pulse width ratio of the LED in each channel as (P1/V1):(P2/V2):(P3/V3).

At step S416, the microprocessor may turn off the color calibration enable signal to make the CALI signal being at a low level. The color calibration switch receives a color calibration enable signal from the microprocessor and enables or disables color calibration based on the received color calibration enable signal. For example, based on the received color calibration enable signal being at a low level, the color calibration switch disables color calibration. In other embodiments, the color calibration switch may disable color calibration based on the received color calibration enable signal being at a high level. However, embodiments of the disclosure are not limited thereto.

In some embodiments, the disclosure also provides an electronic device including a regulated power supply module and a circuit 100 for multi-color LED mixed color balance calibration, wherein the circuit 100 is configured to be connected to the regulated power supply module.

As described above, the circuit 100 for multi-color LED mixed color balance calibration includes an LED loop including one or more LED channels with different colors, each of which includes one or more LEDs with the same color and an LED switch; an LED junction configured to be connected to the one or more LED channels with different colors; a voltage divider resistor configured to be connected between the LED junction and the color calibration switch; a color calibration switch configured to enable or disable color calibration based on the received color calibration enable signal; and a microprocessor configured to generate a color calibration enable signal, measure a first voltage at the LED junction when each of the one or more LED channels with different colors is individually turned on based on the generated color calibration enable signal, and adjust the mixed color output by the LED loop based on the measured first voltage.

Although the disclosure has been described with exemplary embodiments, various changes and modifications can be suggested to those skilled in the art. The disclosure intends to cover such changes and modifications that fall within the scope of the appended claims.

Any description in this disclosure should not be understood as implying that any specific element, step or function is an essential element that must be included in the scope of the claims. The scope of the patent subject matter is limited only by the claims.

1. A circuit for multi-color light-emitting diode (LED) mixed color balance calibration, the circuit comprising:
an LED loop comprising one or more LED channels with different colors, each of the one or more LED channels with different colors comprises one or more LEDs with a same color and an LED switch;
an LED junction configured to be connected to the one or more LED channels with different colors;
a voltage divider resistor configured to be connected between the LED junction and a color calibration switch;
the color calibration switch configured to enable or disable color calibration based on a received color calibration enable signal; and
a microprocessor configured to:
generate a color calibration enable signal,
measure, based on the generated color calibration enable signal, a first voltage at the LED junction when each of the one or more LED channels with different colors is individually turned on, and
adjust a mixed color output by the LED loop based on the measured first voltage.

2. The circuit according to claim 1, wherein,
the microprocessor is configured to, send a turn-on signal for the LED switch corresponding to the one or more LED channels with different colors to the LED loop, based on the color calibration enable signal.

3. The circuit according to claim 1, wherein,
the microprocessor is configured to adjust, based on the measured first voltage when each of the one or more LED channels with different colors is individually turned on, a turn-on pulse width of a turn-on signal for the LED switch corresponding to the one or more LED channels with different colors.

4. The circuit according to claim 1, wherein,
when the received color calibration enable signal is at a high level, the color calibration switch enables color calibration.

5. The circuit according to claim 1, wherein,
the microprocessor is further configured to determine, according to the color calibration enable signal, whether an LED short-circuit occurs in each of the one or more LED channels with different colors, based on the first voltage at the LED junction when each of the one or more LED channels with different colors is individually turned on, to turn off the LED switch corresponding to the LED channel determined to have an LED short circuit.

6. The circuit according to claim 1, wherein,
the LED loop comprises N LED channels with different colors, wherein N is an integer greater than or equal to 2.

7. The circuit according to claim 1, wherein,
each of the one or more LED channels with different colors further comprises one or more LED series resistors connected to a corresponding one of one or more LED with different colors.

8. The circuit according to claim 1, wherein,
the LED switch corresponding to the one or more LED channels with different colors is a metal oxide semiconductor field effect transistor (MOSFET), and a gate of a corresponding LED switch receives a turn-on signal for the LED switch corresponding to the one or more LED channels with different colors from the microprocessor.

9. The circuit according to claim 1, wherein the circuit further comprises:
an LED short-circuit protection switch configured to be connected to the LED junction, and
an LED short-circuit detection module configured to be connected to the LED junction and the LED short-circuit protection switch, measure a second voltage at the LED junction based on the received color calibration enable signal, and determine whether an LED short-circuit occurs to turn off or turn on the LED short-circuit protection switch based on the measured second voltage.

10. The circuit according to claim 9, wherein,
the LED short-circuit protection switch is configured to be turned on when the received color calibration enable signal is at a low level, and the LED short-circuit detection module measures the second voltage at the LED junction.

11. An electronic device, comprising:
a regulated power supply module; and
a circuit configured for multi-color light-emitting diode (LED) mixed color balance calibration and further configured for connection to the regulated power supply module; the circuit, comprising:
an LED loop comprising one or more LED channels with different colors, each of the one or more LED channels with different colors comprises one or more LEDs with a same color and an LED switch;
an LED junction configured to be connected to the one or more LED channels with different colors;
a voltage divider resistor configured to be connected between the LED junction and a color calibration switch; the color calibration switch configured to enable or disable color calibration based on a received color calibration enable signal; and
a microprocessor configured to:
generate a color calibration enable signal,
measure, based on the generated color calibration enable signal, a first voltage at the LED junction when each of the one or more LED channels with different colors is individually turned on, and
adjust a mixed color output by the LED loop based on the measured first voltage.
